(19) United States
(12) Patent Application Publication
(10) Pub. No.: US 2026/0160921 A1
(43) Pub. Date: Jun. 11, 2026

(54) Temporal distribution pattern-based medium-term streamflow forecasting method and system

(71) Applicant: BUREAU OF HYDROLOGY, CHANGJIANG WATER RESOURCES COMMISSION, Wuhan (CN)

(72) Inventors: Wenjing NIU, Wuhan (CN); Baofei FENG, Wuhan (CN); Jun XIA, Wuhan (CN); Zhongkai FENG, Wuhan (CN); Yurong LI, Wuhan (CN); Yinshan XU, Wuhan (CN); Ming ZENG, Wuhan (CN); Fang CHEN, Wuhan (CN); Fangjia YAN, Wuhan (CN); Zhenghua WANG, Wuhan (CN); Zhihui GONG, Wuhan (CN); Xinyue ZHANG, Wuhan (CN); Xinyue YANG, Wuhan (CN); Shenglan JIAN, Wuhan (CN); Muqin KUAI, Wuhan (CN)

(73) Assignee: BUREAU OF HYDROLOGY, CHANGJIANG WATER RESOURCES COMMISSION, Wuhan (CN)

(21) Appl. No.: 19/307,067

(22) Filed: Aug. 22, 2025

(30) Foreign Application Priority Data
Dec. 10, 2024 (CN) 202411803469.9

(51) Int. Cl. G01W 1/10; G01W 1/14

(52) U.S. Cl. CPC G01W 1/10; G01W 1/14

(57) ABSTRACT

A temporal distribution pattern-based medium-term streamflow forecasting method includes: acquiring and organizing long-series hydrological streamflow data from a control cross-section of a study basin, including flow data at daily, ten-day, monthly, seasonal, and yearly scales from a hydrological station and inflow data from a reservoir station; performing streamflow restoration calculation based on a water balance principle, and obtaining a natural streamflow series for any basin node; performing an inflow frequency analysis, and determining seasonal and monthly inflow frequencies of any node in different inflow years; calculating distribution ratios of each month's streamflow at any node across first, middle and last ten-day periods, and defining a temporal streamflow distribution coefficient for the corresponding month; and identifying a historical year with a similar characteristic based on a monthly natural flow at a specific cross-section, matching the temporal distribution coefficient of a historical streamflow series, and deriving a forecasted medium-term natural flow value.

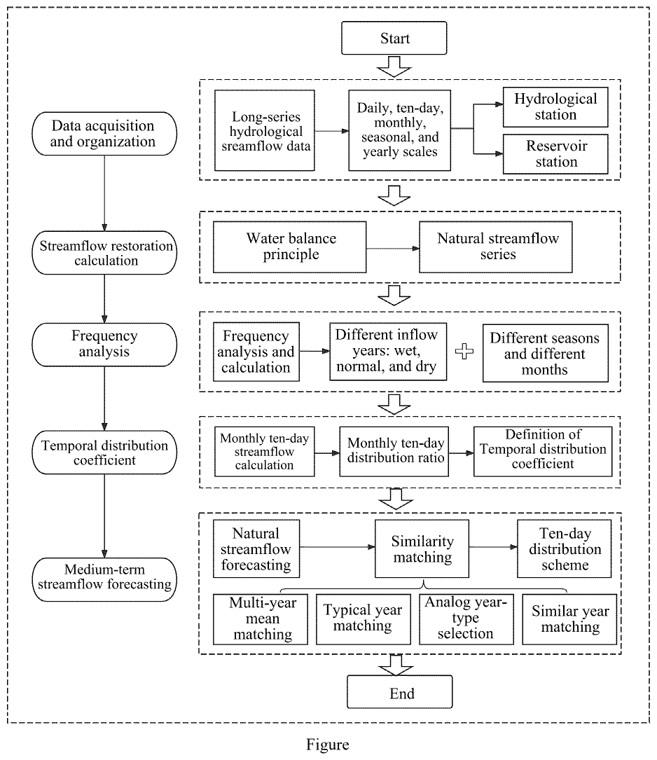

### CROSS REFERENCE TO THE RELATED APPLICATIONS

This application is based upon and claims priority to Chinese Patent Application No. 202411803469.9, filed on Dec. 10, 2024, the entire contents of which are incorporated herein by reference.

### TECHNICAL FIELD

The present disclosure relates to the technical field of hydrology and water resources forecasting and operation, and in particular to a temporal distribution pattern-based medium-term streamflow forecasting method and system.

### BACKGROUND

As a core element of basin water resources management, streamflow forecasting is particularly important for flood control and disaster mitigation, hydropower generation benefits, and agricultural irrigation, etc. Currently, water resources are becoming increasingly strained, and climate change is intensified. Against the backdrop, accurate medium-to-long-term hydrological forecasting has become a crucial tool for guiding optimal allocation of water resources, optimizing reservoir operation strategies, and effectively addressing flood control and drought mitigation challenges. Facing the urgent needs and challenges in water resources management, China's demand for efficient water resources management and intelligent reservoir operation continues to increase. This imposes higher requirements on the accuracy and reliability of medium-to-long-term streamflow forecasting.

The frequent occurrence of extreme weather events caused by climate change and the intensification of human activities have exacerbated the uncertainty of streamflow variations. Frequent changes in streamflow limit the applicability and accuracy of traditional forecasting methods. Although research in the field of medium-to-long-term streamflow forecasting has made some progress, it remains largely in a stage of continuous exploration and refinement. Compared to short-term streamflow forecasting, medium-to-long-term forecasting still exhibits certain gaps in accuracy, timeliness, and meeting practical production demands. Therefore, improving the accuracy and reliability of streamflow forecasting and enabling more precise streamflow forecasts still presents important research directions and challenges.

The flourishing development of diverse models and theories in the field of streamflow forecasting provides new ideas for medium-to-long-term streamflow forecasting research. However, each model and technique has its own advantages and limitations. To meet the demand for accurate streamflow forecasting, it is still necessary to explore more effective forecasting methods to provide technical support for medium-to-long-term streamflow forecasting models and methods.

### SUMMARY

Aiming to address the shortcomings of the prior art described above, an objective of the present disclosure is to provide a temporal distribution pattern-based medium-term streamflow forecasting method and system. The present disclosure defines a monthly temporal streamflow distribution coefficient to match similar streamflow processes in historical years, enabling monthly ten-day natural streamflow flow forecasting.

To achieve the above objective, the present disclosure adopts the following technical solutions:

The present disclosure provides a temporal distribution pattern-based medium-term streamflow forecasting method, including:
S1: acquiring and organizing long-series hydrological streamflow data of a control cross-section in a study basin, including flow data Q_{i,t} at daily, ten-day, monthly, seasonal, and yearly scales from a hydrological station and inflow data

$${Q}_{i , t}^{i n}$$

from a reservoir station;
S2: performing, for any node, a streamflow restoration calculation based on a water balance principle to restore an influence from a reservoir group operation upstream of a cross-section where the node is located to the cross-section; and obtaining a natural streamflow series of the basin node, specifically:

$${Q}_{i , t}^{N} = {Q}_{i , t} + Δ {q}_{i , t}^{up} ; or$$

$${Q}_{i , t}^{N} = {Q}_{i , t}^{in} + Δ {q}_{i , t}^{up} ;$$

where,

$${Q}_{i , t}^{N}$$

denotes a natural flow at a cross-section (at a time t, m³/s; Q_{i,t} denotes an actual flow, provided by the hydrological station, at the cross-section i at the time t;

$${Q}_{i , t}^{in}$$

denotes an actual flow, provided by the reservoir station, at the cross-section i at the time t;

$$Δ {q}_{i , t}^{up}$$

denotes an influence quantity of a reservoir group upstream of the cross-section i on the flow at the cross-section i at the time t; and the time t considers a propagation time influence, where a discharge flow from the upstream reservoir group propagates to the cross-section i at the time t;
S3: performing an inflow frequency analysis on yearly, seasonal and monthly natural streamflow series of any node; and determining inflow frequencies for different seasons and different months in wet, normal, and dry inflow years as follows:

$$P = \frac{m}{n + 1} \times 100 \% ;$$

where, different years, seasons, or months are sorted in descending order of average streamflow; m denotes a rank of a specific year, season, or month; n denotes a total number of years, seasons, or months being sorted; and P denotes the inflow frequency;
S4: calculating, based on the natural streamflow series of each node, distributions of each month's streamflow at different ten-days across first, middle and last ten-day periods; and defining a distribution ratio across the first, middle and last ten-day periods of each month as a temporal streamflow distribution coefficient for the corresponding month; and
S5: matching, based on a monthly natural flow at a specific cross-section of the study basin obtained from hydro-meteorological forecasting, a temporal distribution coefficient of a historical streamflow series according to yearly, seasonal and monthly characteristics and a similarity to a historical year; and deriving a monthly ten-day streamflow distribution scheme, including forecasted natural flow values for each ten-day period.

Furthermore, in the step S1, the long-series hydrological streamflow data refers to flood season reporting data or compiled data; if there is compiled data, the compiled data is applied; if there is no compiled data, the flood season reporting data is applied; for data of different scales, daily, ten-day and monthly compiled data or flood season reporting data are prioritized; if there is no ten-day or monthly compiled or flood season reporting data, daily data Q_{d} is applied to calculate ten-day or monthly supplementary data, specifically:

$${Q}_{xun} = \frac{{\sum }_{a = 1}^{sum} {Q}_{d}}{{sum}_{xun}} ;$$

$${Q}_{mon} = \frac{{\sum }_{a = 1}^{sum} {Q}_{d}}{{sum}_{mon}} ;$$

where, Qₓᵤₙ denotes a ten-day natural flow at a cross-section, m³/s; Qₘₒₙ denotes a monthly natural flow at the cross-section, m³/s; Q_{d} denotes a daily natural flow at the cross-section, m³/s; and sumₓᵤₙ and sumₘₒₙ denote a number of days counted on a ten-day scale and a number of days counted on a monthly scale, respectively.

Furthermore, in the step S4, the temporal streamflow distribution coefficient is a multi-dimensional vector, specifically:

$$x = {Q}_{xun}^{u} : {Q}_{xun}^{l} : {Q}_{xun}^{d} ;$$

where, X denotes a temporal streamflow distribution coefficient for a specific month at a specific cross-section; and

$${Q}_{xun}^{u} , {Q}_{xun}^{l} , and {Q}_{xun}^{d} ;$$

denote natural flows for first, middle and last ten-day periods of the specific month, respectively, m³/s.

Furthermore, in the step S5, the matching refers to a matching process between a forecast object and a historical streamflow process.

Furthermore, a temporal distribution pattern-based medium-term streamflow forecasting system includes: at least one processor and a memory communicatively connected to the at least one processor, where

the memory is configured to store an instruction executable by the processor; and the instruction is executed by the processor to implement the temporal distribution pattern-based medium-term streamflow forecasting method.

The present disclosure has following beneficial effects. The temporal distribution pattern-based medium-term streamflow forecasting method includes: acquiring and organizing long-series hydrological streamflow data from a main control cross-section of a study basin, including flow data at daily, ten-day, monthly, seasonal, and yearly scales from a hydrological station and inflow data from a reservoir station; performing a streamflow restoration calculation based on a water balance principle, and obtaining a natural streamflow series for any basin node; performing an inflow frequency analysis, and determining seasonal and monthly inflow frequencies of any node in different inflow years; calculating distribution ratios of each month's streamflow at any node across first, middle and last ten-day periods, and defining a temporal streamflow distribution coefficient for the corresponding month; and identifying a historical year with a similar characteristic based on a monthly natural flow at a specific cross-section, matching the temporal distribution coefficient of a historical streamflow series, and deriving a forecasted ten-day natural flow value. The present disclosure matches the temporal distribution of the historical streamflow series to obtain the monthly ten-day streamflow distribution scheme, providing important technical support for medium-to-long-term hydro-meteorological forecasting.

### BRIEF DESCRIPTION OF THE DRAWINGS

FIGURE is a flowchart of a temporal distribution pattern-based medium-term streamflow forecasting method.

### DETAILED DESCRIPTION OF THE EMBODIMENTS

To make the objectives, technical solutions, and advantages of the present disclosure clearer, the following describes the present disclosure in more detail with reference to the drawings. It should be understood that the specific embodiments described herein are merely intended to explain the present disclosure, but not to limit the present disclosure.

Referring to FIGURE, a temporal distribution pattern-based medium-term streamflow forecasting method includes following steps.
S1. Long-series hydrological streamflow data of a control cross-section in a study basin are acquired and organized, including flow data Q_{i,t} at daily, ten-day, monthly, seasonal, and yearly scales from a hydrological station and inflow data

$${Q}_{i , t}^{in}$$

from a reservoir station.
S2. For any node, a streamflow restoration calculation is performed based on a water balance principle to restore an influence from a reservoir group operation upstream of a cross-section where the node is located to the cross-section; and obtaining a natural streamflow series of the basin node, specifically:

$${Q}_{i , t}^{N} = {Q}_{i , t} + Δ {q}_{i , t}^{up} ; or$$

$${Q}_{i , t}^{N} = {Q}_{i , t}^{in} + Δ {q}_{i , t}^{up} ;$$

where,

$${Q}_{i , t}^{N}$$

denotes a natural flow at cross-section i at time t, m³/s; Q_{i,t} denotes an actual flow, provided by the hydrological station, at the cross-section i at the time t;

$${Q}_{i , t}^{in}$$

denotes an actual flow, provided by the reservoir station, at the cross-section i at the time t;

$$Δ {q}_{i , t}^{up}$$

denotes an influence quantity of a reservoir group upstream of the cross-section i on the flow at the cross-section i at the time t; and the time t considers a propagation time influence, where a discharge flow from the upstream reservoir group propagates to the cross-section i at the time t
S3. An inflow frequency analysis is performed on yearly, seasonal and monthly natural streamflow series of any nod, and inflow frequencies are determined for different seasons and different months in wet, normal, and dry inflow years as follows:

$$P = \frac{m}{n + 1} \times 100 \% ;$$

where, different years, seasons, or months are sorted in descending order of average streamflow; m denotes a rank of a specific year, season, or month; n denotes a total number of years, seasons, or months being sorted; and P denotes the inflow frequency.

The inflow frequency analysis is configured to determine the similarity between the forecast year and historical typical years, including exceptionally wet years, wet years, median water years, dry years, and exceptionally dry years. The monthly and seasonal streamflow frequency analysis is conducted to determine the similarity between the month or season of the forecast ten-day period and typical historical processes.
S4. Based on the natural streamflow series of each node, distributions of each month's streamflow at different ten-days across first, middle and last ten-day periods are calculated, and a distribution ratio across the first, middle and last ten-day periods of each month is defined as a temporal streamflow distribution coefficient for the corresponding month.
S5. Based on a monthly natural flow at a specific cross-section of the study basin obtained from hydro-meteorological forecasting, a temporal distribution coefficient of a historical streamflow series is matched according to yearly, seasonal and monthly characteristics and a similarity to a historical year, and a monthly ten-day streamflow distribution scheme is derived, including forecasted natural flow values for each ten-day period.

In the step S1, the long-series hydrological streamflow data refers to flood season reporting data or compiled data; if there is compiled data, the compiled data is applied; if there is no compiled data, the flood season reporting data is applied; for data of different scales, daily, ten-day and monthly compiled data or flood season reporting data are prioritized; if there is no ten-day or monthly compiled or flood season reporting data, daily data Q_{d} is applied to calculate ten-day or monthly supplementary data, specifically:

$${Q}_{xun} = \frac{{\sum }_{a = 1}^{sum} {Q}_{d}}{{sum}_{xun}} ;$$

$${Q}_{mon} = \frac{{\sum }_{a = 1}^{sum} {Q}_{d}}{{sum}_{mon}} ;$$

where, Qₓᵤₙ denotes a ten-day natural flow at a cross-section, m³/s; Qₘₒₙ denotes a monthly natural flow at the cross-section, m³/s; Q_{d} denotes a daily natural flow at the cross-section, m³/s; and sumₓᵤₙ and sumₘₒₙ denote a number of days counted on a ten-day scale and a number of days counted on a monthly scale, respectively.

In the step S4, the temporal streamflow distribution coefficient is a multi-dimensional vector, specifically:

$$x = {Q}_{xun}^{u} : {Q}_{xun}^{l} : {Q}_{xun}^{d} ;$$

where, X denotes a temporal streamflow distribution coefficient for a specific month at a specific cross-section; and

$${Q}_{xun}^{u} , {Q}_{xun}^{l} , and {Q}_{xun}^{d}$$

denote natural flows for first, middle and last ten-day periods of the specific month, respectively, m³/s.

In the step S5, the matching refers to a matching process between a forecast object and a historical streamflow process.

The specific matching method includes a multi-year mean matching method, a typical year matching method, a similar year matching method, and a critical period matching method.

The multi-year mean matching method selects a mean yearly inflow and uses the temporal distribution of a mean yearly inflow process as the basis for forecasting.

The typical year matching method selects an inflow from a similar historical typical year and uses the temporal streamflow distribution coefficient of the similar typical year as the basis for forecasting.

The similar year matching method selects a historical year with a similar inflow frequency and uses the temporal streamflow distribution of the similar year as the basis for forecasting.

The critical period matching method matches the period of the forecast object with historical periods and selects the temporal streamflow distribution of a similar historical period as the basis for forecasting.

A temporal distribution pattern-based medium-term streamflow forecasting system includes: at least one processor and a memory communicatively connected to the at least one processor.

The memory is configured to store an instruction executable by the processor; and the instruction is executed by the processor to implement the temporal distribution pattern-based medium-term streamflow forecasting method.

### EMBODIMENT

The 1956-2024 inflow streamflow data of a Danjiangkou Reservoir cross-section in the Han River Basin, China, were acquired. The February data of each year were selected as a calculation example. Streamflow restoration calculation was performed to restore the influence of a reservoir group operation upstream of the cross-section where the node is located to the cross-section, as shown in Table 1. The 1956-2023 data series was taken as a calculation period and the 2024 data was taken as a verification period. An inflow frequency analysis was conducted on the 1956-2023 natural streamflow series, as shown in Table 2. The February temporal streamflow distribution coefficients were calculated based on the historical data series. The similar year matching method was adopted to match the historical temporal streamflow distribution. The February 2024 inflow frequency was comparable to the February 2012 inflow frequency. The February 2012 temporal streamflow distribution coefficient was selected as the basis for forecasting the inflow for each ten-day period in February 2024. Specific forecasting results are shown in Table 3. Absolute errors serve as the accuracy evaluation index. The accuracy evaluation results are shown in Table 3. The absolute errors for all ten-day periods are within 10%.

TABLE 1
February Natural Streamflow Series of Danjiangkou Reservoir

| | Natural streamflow |
|---|---|
| Year | (m³) |
| 1956 | 257 |
| 1957 | 273 |
| 1958 | 139 |
| 1959 | 454 |
| 1960 | 187 |
| 1961 | 229 |
| 1962 | 297 |
| 1963 | 207 |
| 1964 | 287 |
| 1965 | 352 |
| 1966 | 280 |
| 1967 | 213 |
| 1968 | 250 |
| 1969 | 408 |
| 1970 | 219 |
| 1971 | 244 |
| 1972 | 296 |
| 1973 | 232 |
| 1974 | 285 |
| 1975 | 326 |
| 1976 | 467 |
| 1977 | 216 |
| 1978 | 199 |
| 1979 | 215 |
| 1980 | 301 |
| 1981 | 262 |
| 1982 | 314 |
| 1983 | 288 |
| 1984 | 315 |
| 1985 | 368 |
| 1986 | 272 |
| 1987 | 172 |
| 1988 | 135 |
| 1989 | 387 |
| 1990 | 580 |
| 1991 | 136 |
| 1992 | 42 |
| 1993 | 474 |
| 1994 | 508 |
| 1995 | 435 |
| 1996 | 371 |
| 1997 | 291 |
| 1998 | 127 |
| 1999 | 126 |
| 2000 | 159 |
| 2001 | 316 |
| 2002 | 105 |
| 2003 | 145 |
| 2004 | 270 |
| 2005 | 184 |
| 2006 | 485 |
| 2007 | 152 |
| 2008 | 203 |
| 2009 | 249 |
| 2010 | 310 |
| 2011 | 235 |
| 2012 | 477 |
| 2013 | 245 |
| 2014 | 200 |
| 2015 | 251 |
| 2016 | 209 |
| 2017 | 331 |
| 2018 | 447 |
| 2019 | 234 |
| 2020 | 386 |
| 2021 | 354 |
| 2022 | 569 |
| 2023 | 389 |
| 2024 | 477 |

TABLE 2
February Inflow Frequency Analysis for Danjiangkou Reservoir

| Rank | Year | Inflow (m³/s) | Inflow frequency (%) |
|---|---|---|---|
| 1 | 1990 | 580 | 1.4 |
| 2 | 2022 | 569 | 2.9 |
| 3 | 1994 | 508 | 4.3 |
| 4 | 2006 | 485 | 5.8 |
| 5 | 2012 | 477 | 7.2 |
| 6 | 1993 | 474 | 8.7 |
| 7 | 1976 | 467 | 10.1 |
| 8 | 1959 | 454 | 11.6 |
| 9 | 2018 | 447 | 13.0 |
| 10 | 1995 | 435 | 14.5 |
| 11 | 1969 | 408 | 15.9 |
| 12 | 2023 | 389 | 17.4 |
| 13 | 1989 | 387 | 18.8 |
| 14 | 2020 | 386 | 20.3 |
| 15 | 1996 | 371 | 21.7 |
| 16 | 1985 | 368 | 23.2 |
| 17 | 2021 | 354 | 24.6 |
| 18 | 1965 | 352 | 26.1 |
| 19 | 2017 | 331 | 27.5 |
| 20 | 1975 | 326 | 29.0 |
| 21 | 2001 | 316 | 30.4 |
| 22 | 1984 | 315 | 31.9 |
| 23 | 1982 | 314 | 33.3 |
| 24 | 2010 | 310 | 34.8 |
| 25 | 1980 | 301 | 36.2 |
| 26 | 1962 | 297 | 37.7 |
| 27 | 1972 | 296 | 39.1 |
| 28 | 1997 | 291 | 40.6 |
| 29 | 1983 | 288 | 42.0 |
| 30 | 1964 | 287 | 43.5 |
| 31 | 1974 | 285 | 44.9 |
| 32 | 1966 | 280 | 46.4 |
| 33 | 1957 | 273 | 47.8 |
| 34 | 1986 | 272 | 49.3 |
| 35 | 2004 | 270 | 50.7 |
| 36 | 1981 | 262 | 52.2 |
| 37 | 1956 | 257 | 53.6 |
| 38 | 2015 | 251 | 55.1 |
| 39 | 1968 | 250 | 56.5 |
| 40 | 2009 | 249 | 58.0 |
| 41 | 2013 | 245 | 59.4 |
| 42 | 1971 | 244 | 60.9 |
| 43 | 2011 | 235 | 62.3 |
| 44 | 2019 | 234 | 63.8 |
| 45 | 1973 | 232 | 65.2 |
| 46 | 1961 | 229 | 66.7 |
| 47 | 1970 | 219 | 68.1 |
| 48 | 1977 | 216 | 69.6 |
| 49 | 1979 | 215 | 71.0 |
| 50 | 1967 | 213 | 72.5 |
| 51 | 2016 | 209 | 73.9 |
| 52 | 1963 | 207 | 75.4 |
| 53 | 2008 | 203 | 76.8 |
| 54 | 2014 | 200 | 78.3 |
| 55 | 1978 | 199 | 79.7 |
| 56 | 1960 | 187 | 81.2 |
| 57 | 2005 | 184 | 82.6 |
| 58 | 1987 | 172 | 84.1 |
| 59 | 2000 | 159 | 85.5 |
| 60 | 2007 | 152 | 87.0 |
| 61 | 2003 | 145 | 88.4 |
| 62 | 1958 | 139 | 89.9 |
| 63 | 1991 | 136 | 91.3 |
| 64 | 1988 | 135 | 92.8 |
| 65 | 1998 | 127 | 94.2 |
| 66 | 1999 | 126 | 95.7 |
| 67 | 2002 | 105 | 97.1 |
| 68 | 1992 | 42 | 98.6 |

TABLE 3
February Ten-Day Inflow Forecasting for Danjiangkou Reservoir

| | First ten- | Middle ten- | Last ten- |
|---|---|---|---|
| | day period | day period | day period |
| Forecasted value (m³/s) | 591 | 645 | 671 |
| Actual value (m³/s) | 544 | 714 | 630 |
| Average error (%) | 8.6 | −9.7 | 6.5 |

| | |
|---|---|
| Average absolute error (%) | 8.3 |

As can be seen from Table 1 to Table 3, the method of the present disclosure adopts a computational approach involving inflow frequency analysis, definition of historical temporal streamflow distribution coefficients, similar year matching, and ten-day natural flow forecasting, enabling rapid implementation of medium-term (ten-day) streamflow forecasting. By fully referencing the streamflow distribution in the historical data series, the present disclosure obtains streamflow forecasting results, demonstrating the feasibility and effectiveness of the method. This indicates that the method has superior application effects in medium-term (ten-day) streamflow forecasting.

Based on the above analysis, the method of the present disclosure is highly practical and can effectively solve the problem of medium-term (ten-day) streamflow forecasting methods.

In summary, the present disclosure has advantages such as strong practicality and operability. It can quickly match the temporal distribution of historical streamflow series, and obtain streamflow forecasting results for key cross-sections, providing a more scientific and efficient new method for hydrological forecasting of basins.

The above embodiments are merely illustrative of some implementations of the present disclosure, and the description thereof is specific and detailed, but should not be construed as limiting the patent scope of the present disclosure. It should be noted that those of ordinary skill in the art can further make several variations and improvements without departing from the concept of the present disclosure, and all of these fall within the protection scope of the present disclosure. Therefore, the patent protection scope of the present disclosure should be subject to the appended claims.

1. A temporal distribution pattern-based medium-term streamflow forecasting method, comprising:
S1: acquiring and organizing long-series hydrological streamflow data of a control cross-section in a study basin, comprising flow data Q_{i,t} at daily, ten-day, monthly, seasonal, and yearly scales from a hydrological station and inflow data
$${Q}_{i , t}^{i n}$$
from a reservoir station;
S2: performing, for any basin node, a streamflow restoration calculation based on a water balance principle to restore an influence from a reservoir group operation upstream of a cross-section where the basin node is located to the cross-section; and obtaining a natural streamflow series of the basin node, wherein:
$${Q}_{i , t}^{N} = {Q}_{i , t} + Δ {q}_{i , t}^{up} ; or$$
$${Q}_{i , t}^{N} = {Q}_{i , t}^{in} + Δ {q}_{i , t}^{up} ;$$
wherein,
$${Q}_{i , t}^{N}$$
denotes a natural flow at a cross-section i at a time t, m³/s; Q_{i,t} denotes an actual flow, provided by the hydrological station, at the cross-section i at the time t;
$${Q}_{i , t}^{i n}$$
denotes an actual flow, provided by the reservoir station, at the cross-section i at the time t;
$$Δ {q}_{i , t}^{up}$$
denotes an influence quantity of a reservoir group upstream of the cross-section 1 on the flow at the cross-section i at the time t; and the time t considers a propagation time influence, wherein a discharge flow from the upstream reservoir group propagates to the cross-section I at the time t;
S3: performing an inflow frequency analysis on yearly, seasonal and monthly natural streamflow series of any basin node; and determining inflow frequencies for different seasons and different months in wet, normal, and dry inflow years as follows:
$$P = \frac{m}{n + 1} \times 100 \% ;$$
wherein, different years, seasons, or months are sorted in descending order of average streamflow; m denotes a rank of a specific year, season, or month; n denotes a total number of years, seasons, or months being sorted; and P denotes the inflow frequency;
S4: calculating, based on the natural streamflow series of each basin node, distributions of each month's streamflow across first, middle and last ten-day periods; and defining a distribution ratio across the first, middle and last ten-day periods of each month as a temporal streamflow distribution coefficient for the corresponding month; and
S5: matching, based on a monthly natural flow at a specific cross-section of the study basin obtained from hydro-meteorological forecasting, a temporal distribution coefficient of a historical streamflow series according to yearly, seasonal and monthly characteristics and a similarity to a historical year; and deriving a monthly ten-day streamflow distribution scheme, comprising forecasted natural flow values for each ten-day period.

2. The temporal distribution pattern-based medium-term streamflow forecasting method according to claim 1, wherein in the step S1, the long-series hydrological streamflow data refers to flood season reporting data or compiled data; when there is compiled data, the compiled data is applied; when there is no compiled data, the flood season reporting data is applied; for data of different scales, daily, ten-day and monthly compiled data or flood season reporting data are prioritized; when there is no ten-day or monthly compiled or flood season reporting data, daily data Q_{d} is applied to calculate ten-day or monthly supplementary data, wherein:
$${Q}_{xun} = \frac{{\sum }_{a = 1}^{sum} {Q}_{d}}{{sum}_{xun}} ;$$
$${Q}_{mon} = \frac{{\sum }_{a = 1}^{sum} {Q}_{d}}{{sum}_{mon}} ;$$
wherein, Qₓᵤₙ denotes a ten-day natural flow at a cross-section, m³/s; Qₘₒₙ denotes a monthly natural flow at the cross-section, m³/s; Q_{d} denotes a daily natural flow at the cross-section, m³/s; and sumₓᵤₙ and sumₘₒₙ denote a number of days counted on a ten-day scale and a number of days counted on a monthly scale, respectively.

3. The temporal distribution pattern-based medium-term streamflow forecasting method according to claim 2, wherein in the step S4, the temporal streamflow distribution coefficient is a multi-dimensional vector, wherein:
$$x = {Q}_{xun}^{u} : {Q}_{xun}^{l} : {Q}_{xun}^{d} ;$$
wherein, X denotes a temporal streamflow distribution coefficient for a specific month at a specific cross-section; and
$${Q}_{xun}^{u} , {Q}_{xun}^{l} , and {Q}_{xun}^{d}$$
denote natural flows for first,
middle and last ten-day periods of the specific month, respectively, m³/s.

4. The temporal distribution pattern-based medium-term streamflow forecasting method according to claim 3, wherein in the step S5, the matching refers to a matching process between a forecast object and a historical streamflow process.

5. A temporal distribution pattern-based medium-term streamflow forecasting system, comprising: at least one processor and a memory communicatively connected to the at least one processor, wherein
the memory is configured to store an instruction executable by the at least one processor; and the instruction is executed by the at least one processor to implement the temporal distribution pattern-based medium-term streamflow forecasting method according to any one of claims 1 to 4.
